(19) United States
(12) Patent Application Publication
(10) Pub. No.: US 2004/0178527 A1
(43) Pub. Date: Sep. 16, 2004

(54) Liquid crystal display manufacture method

(75) Inventors: Chi-Chang Liao, Hsinchu (TW); Chih-Ming Lai, Hsinchu (TW); Ing-Jer Lin, Hsinchu (TW); Yi-Chun Wong, Hsinchu (TW); Lung-Pin Hsin, Hsinchu (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/637,697

(22) Filed: Aug. 11, 2003

(30) Foreign Application Priority Data
Mar. 12, 2003 (TW) 092105412

(51) Int. Cl. B29D 11/00

(52) U.S. Cl. 264/1.34; 264/1.38

(57) ABSTRACT

A method for manufacturing the liquid crystal display, which mainly use a auxiliary substrate with polymeric material containing liquid crystal to proceed a photo polymerization process, and then use a first polymeric material layer to proceed a process with plurality electrode, alignment layer and flanges setting in. A second polymeric material mixture coating on a substrate which has plurality electrode pattern an alignment layer and flanges on it. And then align the auxiliary substrate and the substrate to proceed exposure process and combine both due to phase separation, finally removing the assist substrate.

### BACKGROUND OF THE INVENTION

1. Field of the Invention

The present invention relates to a method for manufacturing liquid crystal display with reduced thickness and weight, especially to a method for manufacturing liquid crystal display with flexible plastic substrate and versatile display modes in high yield.

2. Description of the Related Art

Flat panel displays have the advantages of reduced volume and weight. But for applications on portable products, the target is to develop flat panel display with lighter weight, thinner size, impact resistance and low power consumption. For this purpose, the research trend of flat panel display is switched from traditional glass substrate to plastic substrate. For example, “thin film manufacturing method of liquid crystal display” (WO 02/42832 A2), applied by PHILIPS in WIPO, is a new process technology for plastic-substrate display; the major concept is to wrap liquid crystal on substrate by using photo polymeric material, shown as FIGS. 1A to 1E. At first, illustrated in FIG. 1A, photo polymeric mixture 2 composed of NOA65 and liquid crystal is coating on a substrate 1; the photo polymeric mixture 2 is smoothed by a knife 3, shown as FIG. 1B; In FIG. 1C, a mask 4 is arranged above the polymeric material mixture 2 and an exposure process is performed by an ultraviolet rays 5. The exposure regions of photo polymeric mixture 2, shown as FIG. 1D, will be cured and polymerized to form a plurality of polymer walls 20. The second process, shown in FIG. 1E, is a long-term and low-intensity exposure by ultraviolet ray 6 and then forms a thin harden layer 21 on the surface of the photo polymeric material mixture 2, completing the phase separate process of liquid crystal and photo polymeric material.

In this prior art proposed by PHILIPS, the process method need twice exposure to implement the polymer structure for wrapping liquid crystal, but performing the second exposure need long-term and low-intensity exposure and has degradation concern for liquid crystal material. It'll induce small process window, low throughput and fewer display modes for application.

To resolve problems above mentioned, this invention provides a manufacture method that rises the throughput and increases variety kinds of LCD modes.

### SUMMARY OF THE INVENTION

This invention is a manufacturing method, which mainly use an auxiliary substrate with polymeric material and then use a first polymeric material layer to proceed a process with plurality electrode, alignment layer and flanges setting in. A second polymeric material mixture coating on a substrate which has plurality electrode pattern an alignment layer and flanges on it. And then align the auxiliary substrate and the substrate to proceed exposure process and combine both of them due to phase separation, finally stripped the assist substrate. The invention can rise the throughput and increase variety kinds of LCD modes.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1(A) to (E) are illustrative views showing a process for one-substrate liquid crystal display of the prior art;

FIGS. 2(A) to 2(K) are illustrative views showing a manufacturing method for one-substrate liquid crystal display in accordance to an embodiment of the present invention;

FIGS. 3(A) to 3(K) are illustrative views showing a manufacturing method for one-substrate liquid crystal display in accordance to another embodiment of the present invention;

FIGS. 4(A) to 4(K) are illustrative views showing a manufacturing method for one-substrate liquid crystal display in accordance to another embodiment of the present invention;

FIGS. 5(A) to 5(L) are illustrative views showing a manufacturing method for no substrate liquid crystal display in accordance to another embodiment of the present invention; and

FIGS. 6(A) to 6(L) are illustrative views showing a manufacturing method for no substrate liquid crystal display in accordance to another embodiment of the present invention.

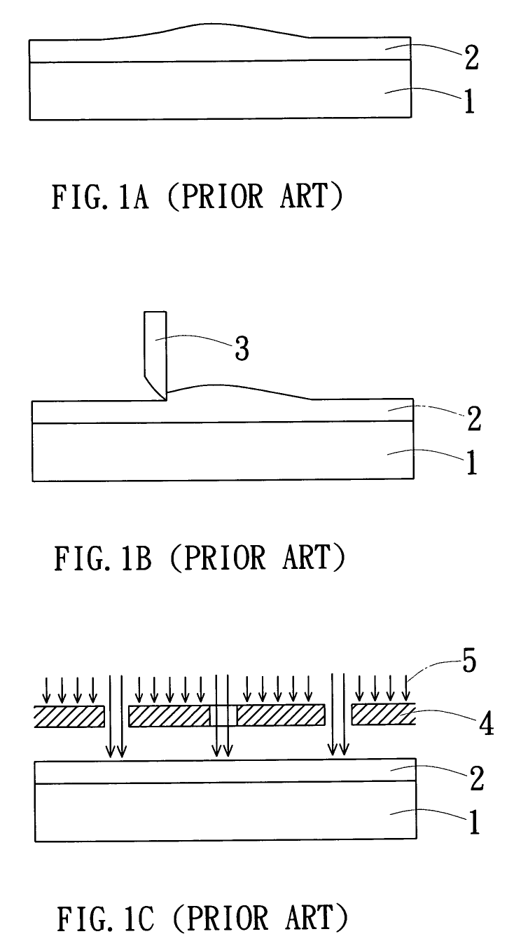

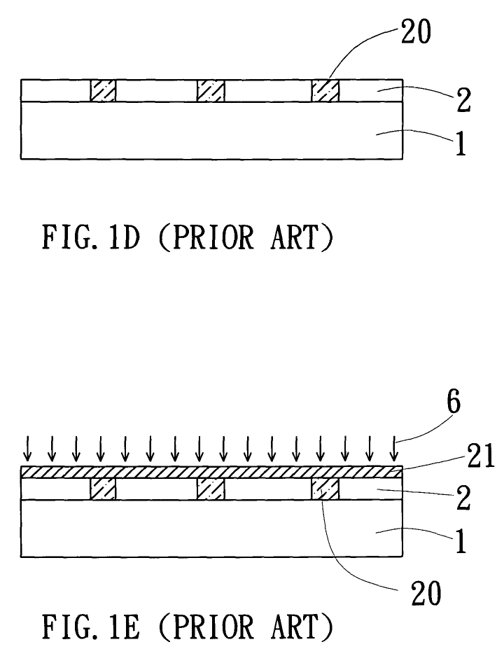

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

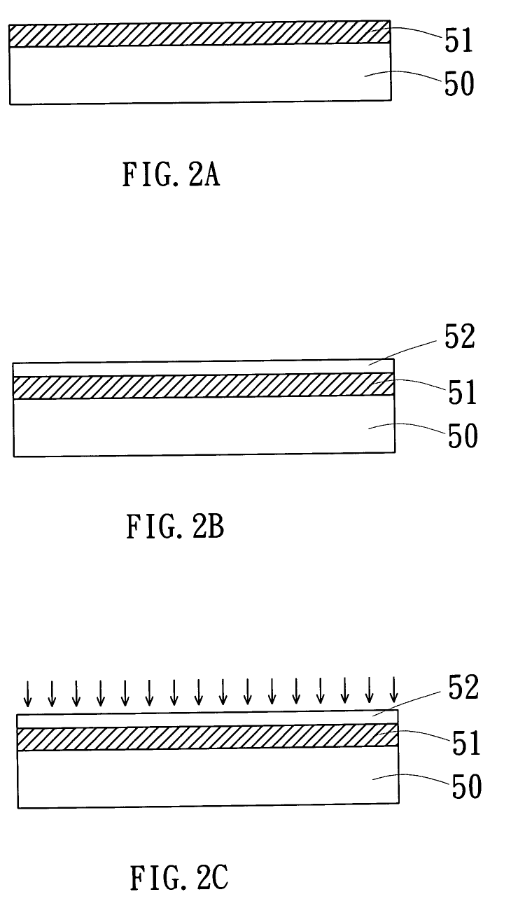

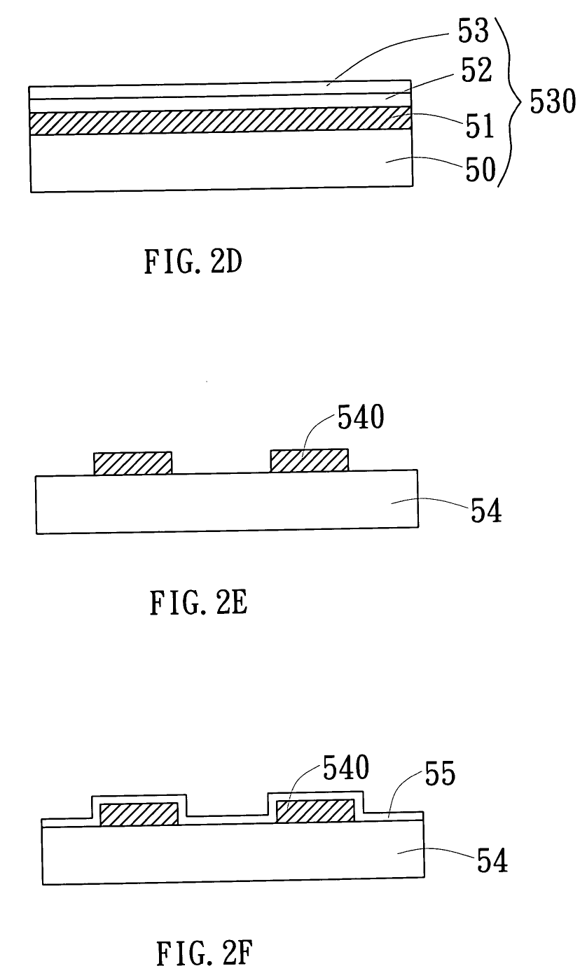

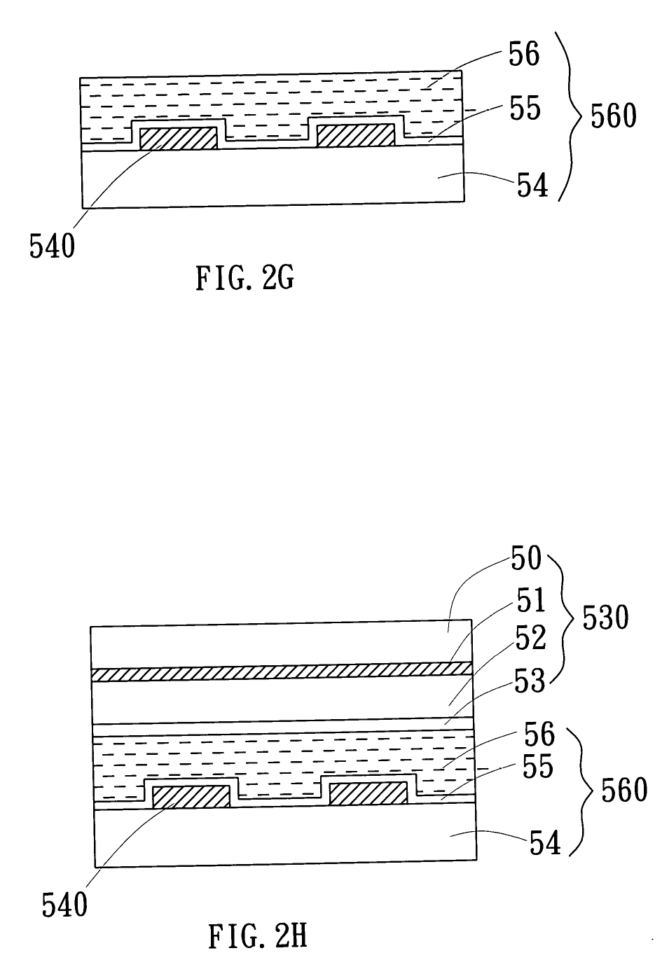

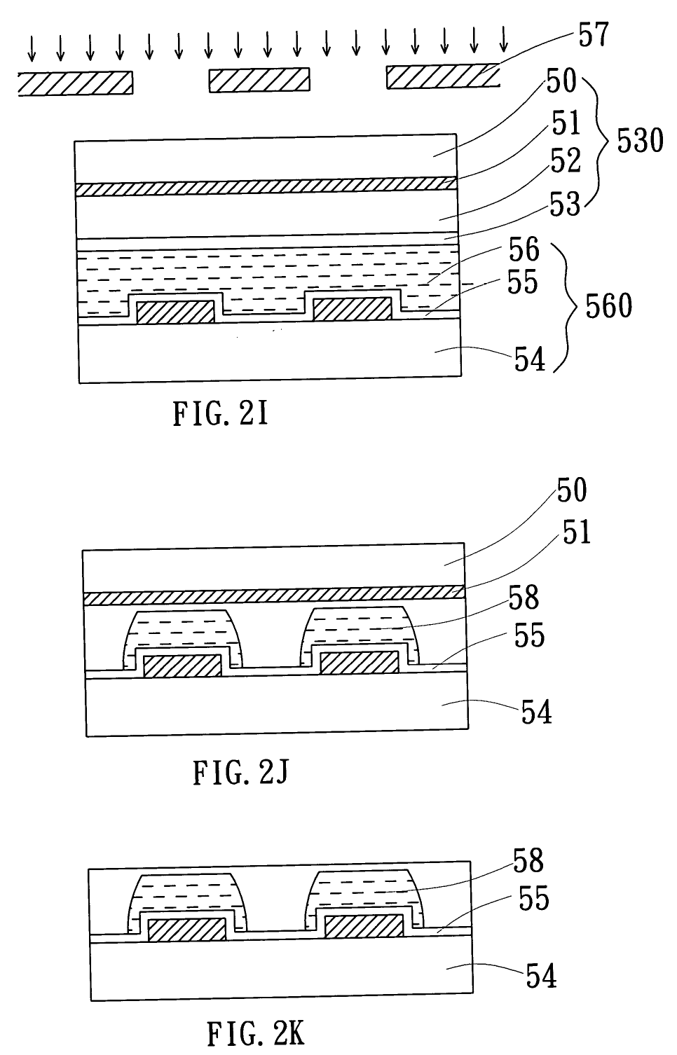

FIGS. 2(A) to 2(K) are illustrative views showing a manufacturing method for one-substrate liquid crystal display in accordance to an embodiment of the present invention, wherein include following steps:

FIGS. 2(A) to 2(D) are illustrative views showing a process step of the first substrate. In FIG. 2(A), a release layer 51 is formed on an auxiliary substrate 50; In FIG. 2(B), a photo polymeric material 52 is coated (for example: NOA65, NOA72) on the release layer 51; In FIG. 2(C), an exposure process is performed by an ultraviolet rays 5 for transferring the photo polymeric material 52 to a cured polymer 52′. In FIG. 2(D), an alignment layer 53 is coated on the polymer 52′ to finish the first substrate 530 process.

FIGS. 2(E) to 2(G) are illustrative views showing a process step of the second substrate. In FIG. 2(E), an electrode pattern 540 is formed on the substrate 54; In FIG. 2(F) an alignment layer 55 is coated on the substrate 54 and the electrode pattern 540. In FIG. 2(G), a photo polymeric material mixture 56, composed of photo polymeric material and liquid crystal, is coated on an alignment layer 55 to finish the second substrate 560.

FIGS. 2(H) to 2(K) are illustrative views showing a assembling step flow of the first 530 and the second substrate 560. In FIG. 2(H), the first substrate 530 is inverted and then placed on the second substrate 560; FIG. 2(I), a mask 57 is placed atop the first substrate 530 and the resulting device is subjected to exposure by ultraviolet rays 5. As shown in FIG. 2(J) after exposure, a plurality of polymer walls 58 is formed and the first 530 and second 560 substrate are assembled such that the liquid crystal material 58 is wrapped by polymer due to phase separation of liquid crystal and photo polymeric material.

FIG. 2(K) shows the step of removing auxiliary substrate 50 and the release layer 51 to finish one-substrate liquid crystal display.

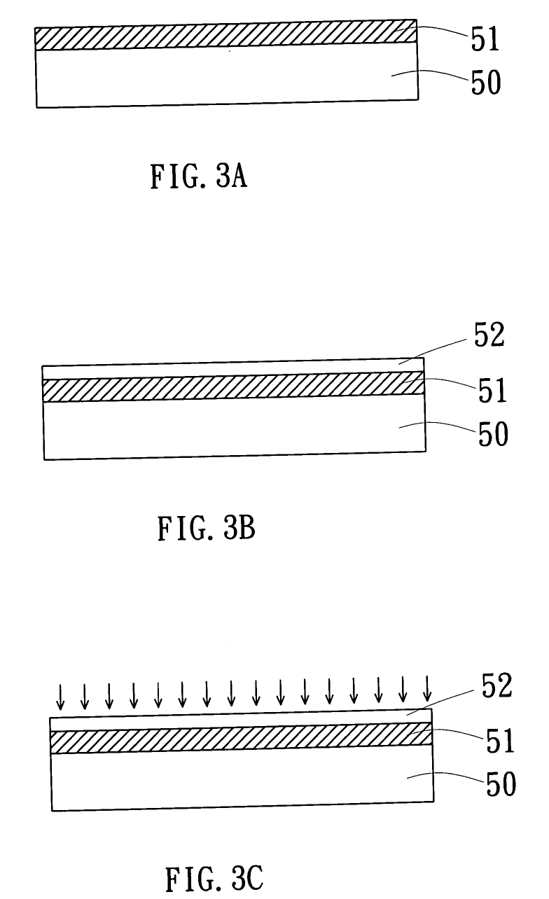

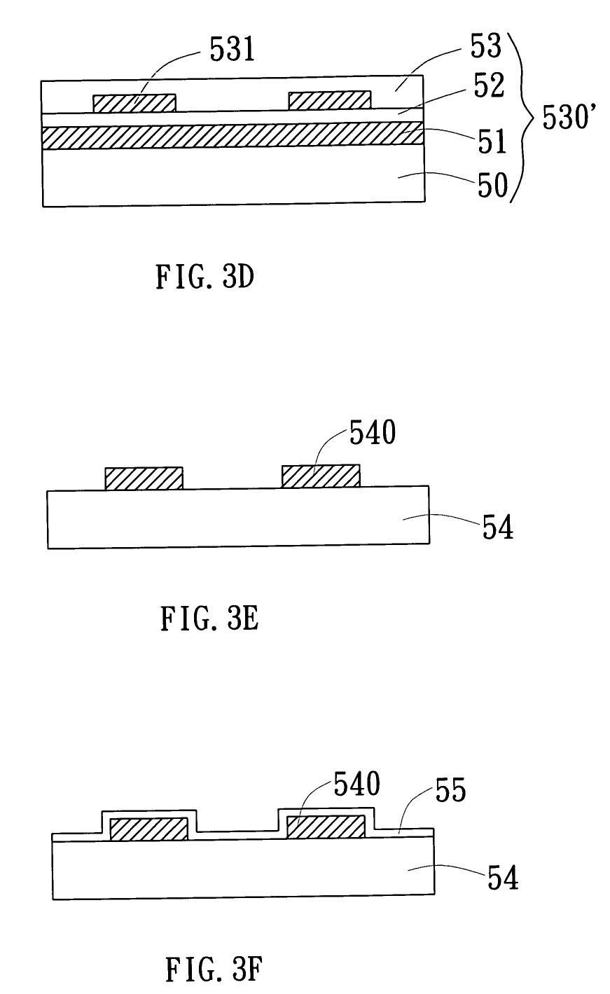

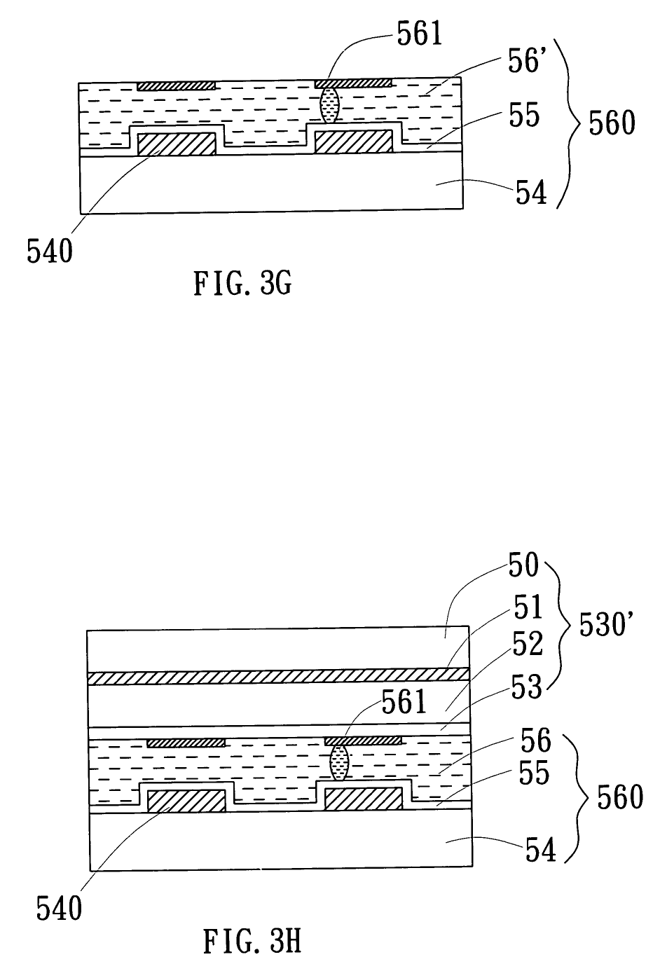

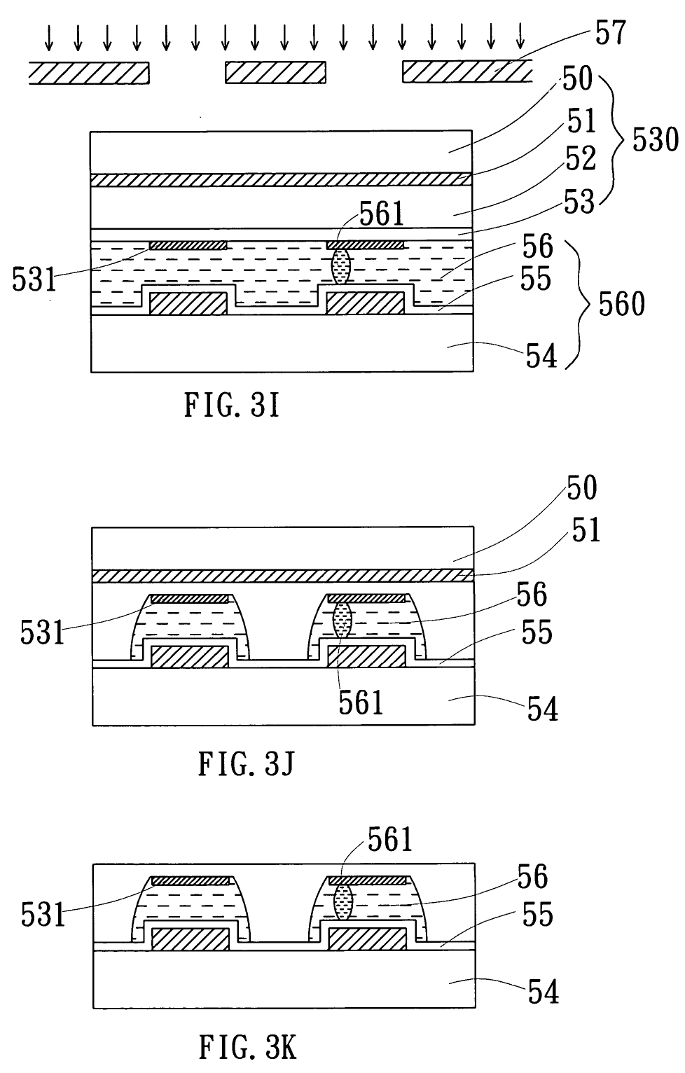

FIGS. 3(A) to 3(K) are illustrative views showing a manufacturing method for one-substrate liquid crystal display in accordance to another embodiment of the present invention, the major difference is that the first substrate has electrode and photo polymeric material mixture is composed by photo polymeric material, liquid crystal and spacer, wherein include following steps:

FIGS. 3(A) to 3(D) are illustrative views showing a process step of the first substrate 530. In FIG. 3(A), a release layer 51 is formed on an auxiliary substrate 50. FIG. 3(B), a photo polymeric material 52 (for example: NOA65, NOA72) is coated on the release layer 51. In FIG. 3(C), an exposure process is performed by ultraviolet rays 5 and transfer photo polymeric material 52 to a cured polymer 52′. In FIG. 3(D), an electrode 531 and flange 532 are formed on polymer 52′ and an alignment layer 53 is coated thereon and then finish the first substrate 530′ process.

FIGS. 3(E) to 3(G) are illustrative views showing a manufacturing step of the second substrate 560. In FIG. 3(E), an electrode pattern 540 and flange 532′ are formed on a substrate 54. In FIG. 3(F) an alignment layer 55 is formed on the substrate 54, the electrode pattern 540 and the flange 532′. In FIG. 3(G) a photo polymeric material mixture 56′, composed of photo polymeric material, liquid crystal and spacer, is coated on the alignment layer 55 and then finish the second substrate 560.

FIGS. 3(H) to 3(K) are illustrative views showing an assembling step flow of the first 530′ and second substrate 560. In FIG. 3(H), to invert the first substrate 530′ on the second substrate 560; FIG. 3(I), put a mask 57 on the first substrate 530′ and proceed exposure by ultraviolet rays 5; FIG. 3(J), after exposure, the formed plurality polymer walls 58 combine the first 530′ and second 560 substrate and the liquid crystal material 59 is wrapped by polymer matrix because of phase separation. FIG. 3(K) shows stripped assist substrate 50 and release layer 51 to finish one-substrate and double-side electrode liquid crystal display with controlled cell gap by spacer.

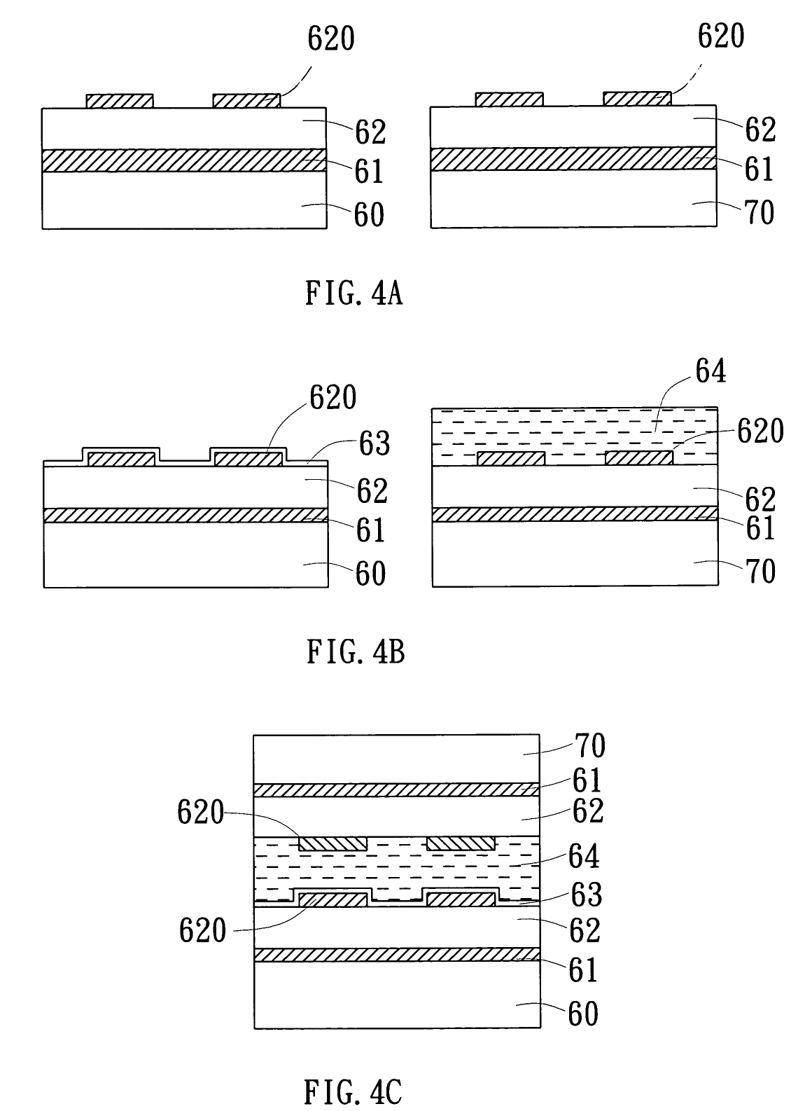

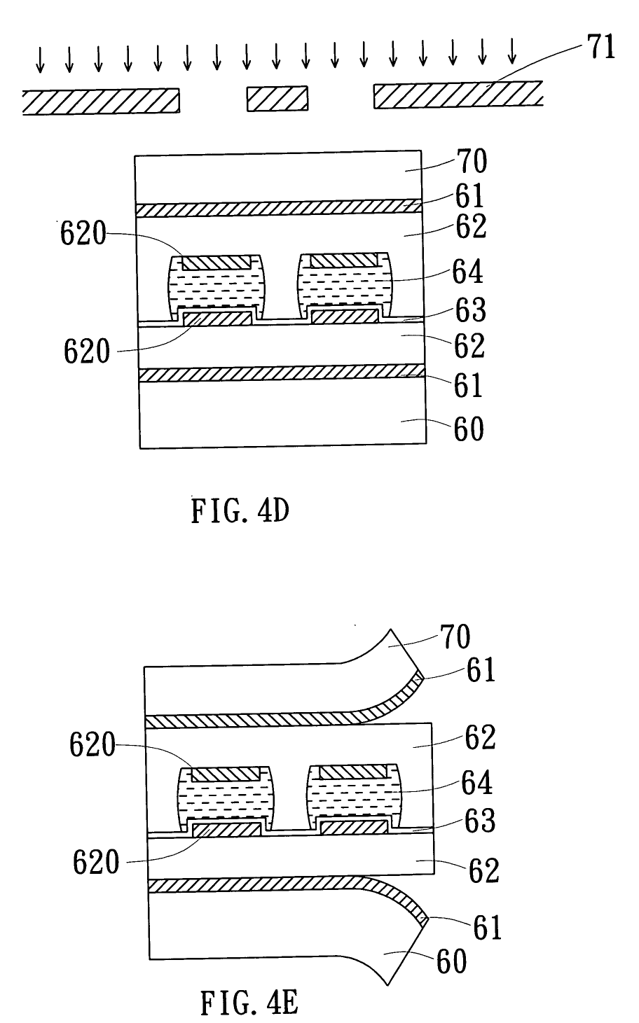

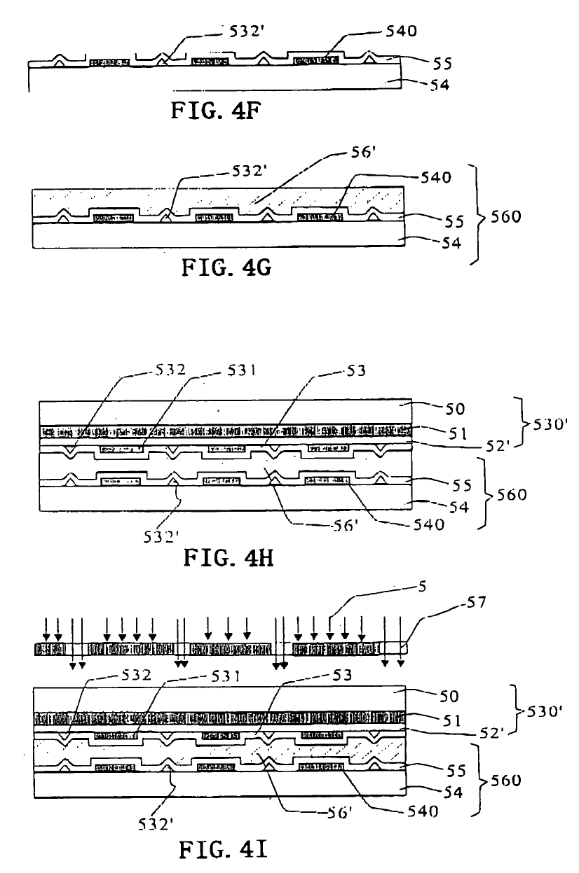

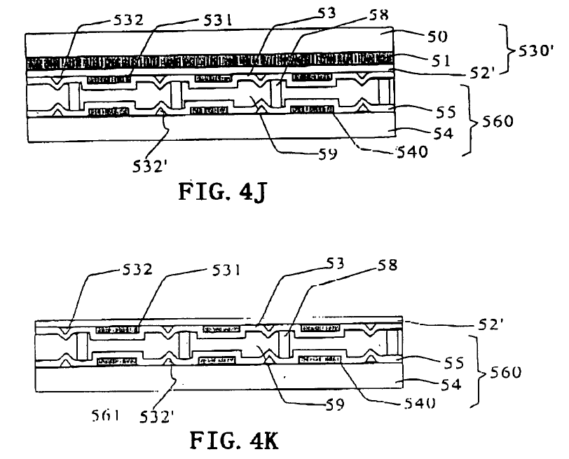

FIGS. 4(A) to 4(K) are illustrative views showing a manufacturing method for liquid crystal display in accordance to another embodiment of the present invention, the major difference is the first substrate with electrode and polymeric material mixture is composed of photo polymeric material and liquid crystal.

FIGS. 4(A) to 4(D) are illustrative views showing a manufacturing step of the first substrate 530′. In FIG. 4(A), producing release layer 51 on a assist substrate 50; FIG. 4(B), coating a photo polymeric material 52 (for example: NOA65, NOA72) on the release layer 51; FIG. 4(C), proceed exposure process by ultraviolet rays 5 to transfer photo polymeric material 52 to polymer 52′; FIG. 4(D), manufacturing electrode 531 and flange 532 on polymer layer 52′ and then coating an alignment layer 53 on it. Finally, finish the first substrate 530′ process.

FIGS. 4(E) to 4(G) are illustrative views showing a manufacturing step of the second substrate 560. In FIG. 4(E), an electrode pattern 540 and flange 532′ are formed on a substrate 54. In FIG. 4(F) an alignment layer 55 is formed on the substrate 54, the electrode pattern 540 and the flange 532′. In FIG. 4(G) a photo polymeric material mixture 56′ composed of photo polymeric material and liquid crystal is coated on the alignment layer 55 and then finish the second substrate 560.

FIGS. 4(H) to 4(K) are illustrative views showing a assembling step flow of the first substrate 530′ and second substrate 560. In FIG. 4(H), the first substrate 530′ is inverted and the placed on the second substrate 560. In FIG. 4(I), a mask 57 is placed atop the first substrate 530′ and is subjected to an exposure by ultraviolet rays 5. In FIG. 4(J), a plurality of polymer walls 58 is formed and the first 530′ and second 560 substrate are combined after exposure. Therefore, the liquid crystal material 59 is wrapped by the polymer due to phase separation of the liquid crystal and the photo polymeric material. FIG. 4(K), the auxiliary substrate 50 and release layer 51 are removed to finish one-substrate and double-side electrode liquid crystal display with controlled cell gap by spacer.

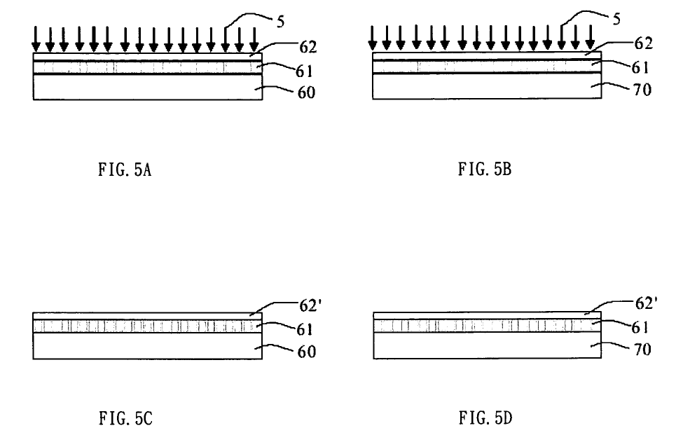

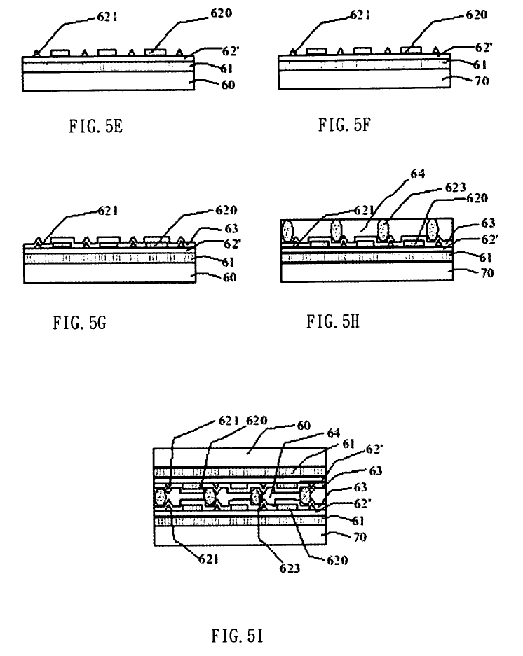

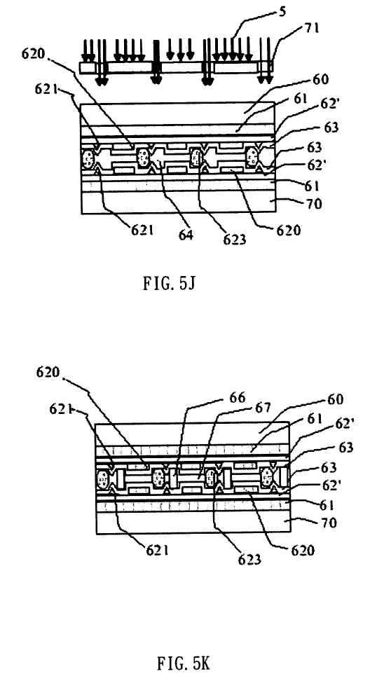

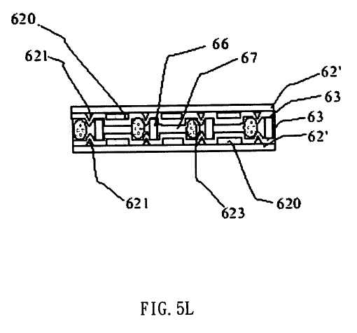

FIGS. 5(A) to 5(L) are illustrative views showing a manufacturing method for no substrate liquid crystal display in accordance to another embodiment of the present invention. In FIG. 5(A), a release layer 61 is formed on the first auxiliary substrate 60. In FIG. 5(B), a release layer 61 is formed on a second auxiliary substrate 70. In FIG. 5(C) and (D), a photo polymeric material 62 is coated on the first and the second auxiliary substrate which have release layer 61 and is subjected to exposure by ultraviolet rays 5 transferring to a cured polymer layer 62. In FIGS. 5(E) and 5(F), an electrode pattern 620 and flange 621 are formed on the cured polymer layer 62′. FIG. 5(G) shows that the first auxiliary substrate 60 with the cured polymer layer 62′ has electrode pattern 620 and flange 621. FIG. 5(H) shows that the second auxiliary substrate 70 with the cured polymer layer 62′, the electrode pattern 620 and flange 621, is coated with an orientation layer 63. Finally a photo polymeric material mixture 64 which composed of photo polymeric material, liquid crystal and spacer is coated thereon. In FIG. 5(I), the second auxiliary substrate 70 on the first auxiliary substrate 60 and proceed exposure after alignment. In FIG. 5(J), a mask 71 is placed atop the first auxiliary substrate 60 and the second auxiliary substrate 70, and then proceed exposure by ultraviolet rays 5; FIG. 5(K) shows that after exposure, a plurality of polymer wall 66 is formed and the first 60 and second 70 auxiliary substrate are combined such that the liquid crystal material 67 is wrapped by the polymer due to phase separation of liquid crystal and photo polymeric material. FIG. 5(L) shows the removing of the first 60, second auxiliary substrate 70 auxiliary and release layer 61 to finish no substrate and double-side electrode liquid crystal display.

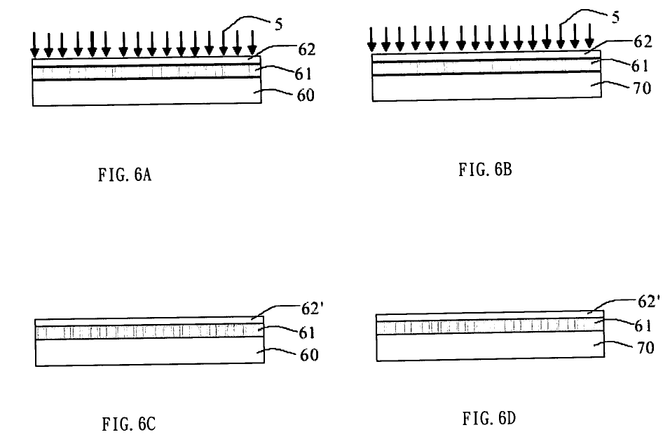

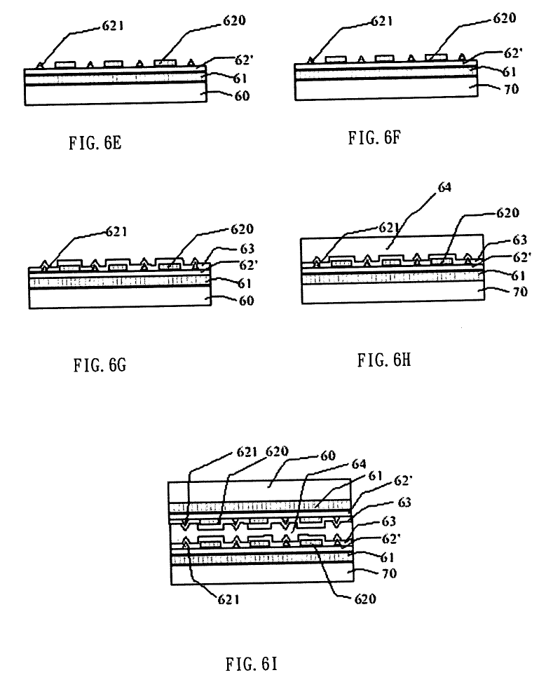

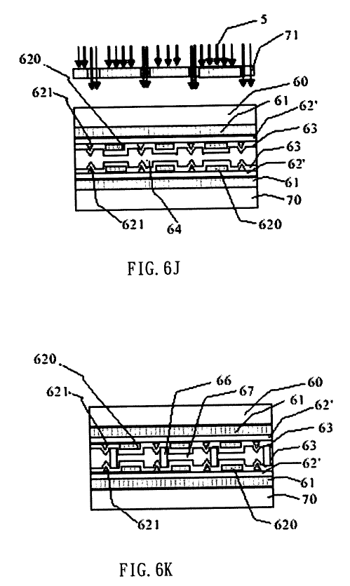

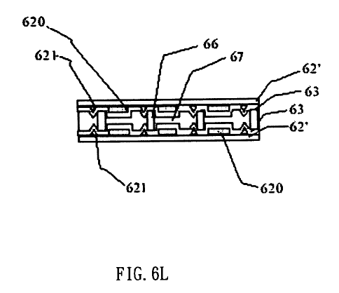

FIGS. 6(A) to 6(L) are illustrative views showing a manufacturing method for no substrate liquid crystal display in accordance to another embodiment of the present invention, the major difference is that the photo polymerization material mixture is composed of photo polymeric material and liquid crystal.

FIGS. 6(A) to 6(B) show the steps of making a release layer 61 on the first auxiliary substrate 60 and second auxiliary substrate 70, coating photo polymeric material 62 thereon it and then proceeding exposure by ultraviolet rays 5; FIGS. 6(C) and 6(D) show that, after exposure, photo polymeric material 62 transfer to a cured polymer layer 62′; FIGS. 6(E) and 6(F) show the steps of manufacturing electrode pattern 620 and flange 621 on the cured polymer layer 62′; FIG. 6(G) shows that the first auxiliary substrate 60 and cured polymer layer 62′ has electrode pattern 620 and flange 621; In FIG. 6(H), the second auxiliary substrate 70 and cured polymer layer 62′ has electrode pattern 620 and flange 621, and then coated by an alignment layer 63, finally coated by photo polymeric material mixture 64 which composed of photo polymeric material, liquid crystal and spacer; In FIG. 6(I), t the second auxiliary substrate 70 is inverted and placed atop the first auxiliary substrate 60 and proceed exposure after alignment; In FIG. 6(J), a mask 71 is placed atop the first auxiliary substrate 60 and the second auxiliary substrate 70, and then proceed exposure by ultraviolet rays 5; FIG. 6(K) shows after exposure, a plurality of polymer wall 66 is formed and the first auxiliary substrate 60 and second auxiliary substrate 70 are combined such that the liquid crystal material 67 is wrapped by polymer due to the phase separation of liquid crystal and photo polymeric material. FIG. 6(L) shows the removing of the first, second auxiliary substrates 60, 70 and release layer 61 to finish no substrate and double-side electrode liquid crystal display.

From the embodiment of the present invention mentioned above, available liquid crystal materials include Nematic, Clolesteric, Ferroelectric, anti-ferroelectric and so on. The additives of liquid crystal materials include dye, chiral molecule and monomer. Display modes include transmitted, reflective and semi-transmitted/semi-reflective liquid crystal display which composed of liquid crystal materials and additives. Operation modes include in-plane switching and non in-plane switching. All embodiments of this invention can be implemented by roll to roll process method to manufacture liquid crystal display. The quantity of electrode and flange in pixel area could be one or plurality.

The liquid crystal display manufacturing method of this invention is detailed explained above, it can resolve drawbacks of one-substrate liquid crystal display of PHILIPS. For example, low-energy and long-time second exposure, material degradation concern, small process window, low throughput and less liquid crystal display modes. This invention shows the advantages of increasing throughput, variety of display modes and providing a method easier wrapping liquid crystal molecule rate and better controlled liquid layer thickness.

As mentioned above, it shows the purpose and efficiency of this invention provided with advanced and value in industry. Meanwhile, it's a new and hither to unknown invention in current market. So apply for a patent base on patent law.

In accordance to the above mention, therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What claimed is:

1. A method for manufacturing the liquid crystal display comprising the steps of:
proceeding a first substrate process, coating a photo polymeric material on an auxiliary substrate with a release layer and exposing and curing the photo polymeric material by an ultraviolet rays; coating a alignment layer on the cured photo polymeric material layer;
proceeding a second substrate process, coating a photo polymeric material mixtures on a substrate which has electrode pattern and a alignment layer; and
proceeding the first and second substrate assembling process,
aligning the auxiliary substrate and the substrate to place the cured photo polymeric material there between,
exposing the cured photo polymeric material to forms a plurality of polymer walls and assembling the first and second substrate to induce liquid crystal material being wrapped by polymer due to phase separation of liquid crystal and photo polymeric material; and removing the auxiliary substrate.

2. The method in accordance with claim 1, wherein the photo polymeric material is photocurable resin.

3. The method in accordance with claim 1, wherein the material of auxiliary substrate or substrate is one of glass, wafer, Teflon and plastic substrate.

4. The method in accordance with claim 1, wherein the electrode pattern material is conducting film.

5. The method in accordance with claim 1, wherein the conducting film is one ITO and polyethylene-dioxithiphene.

6. The method in accordance with claim 1, wherein the release layer material is PE/PEWax, long-chain Aliphatic, Silicone and Teflon type materials.

7. The method in accordance with claim 1, wherein further comprising a manufacturing electrode step on the auxiliary substrate within the first substrate process step.

8. The method in accordance with claim 1, wherein the alignment layer process method is performed by rubbing alignment, photoalignment, ion beam alignment or microgroove alignment and so on.

9. The method in accordance with claim 8, wherein the phase materials is one of polyimide, polyamic or photoalignment.

10. The method in accordance with claim 1, futher comprising a step of making special electrode pattern or flange on the auxiliary substrate or substrate the flange being organic material.

11. The method in accordance with claim 1, wherein the polymer wall is closed matrix polymer wall.

12. The method in accordance with claim 1, wherein the polymer wall which is non-closed matrix polymer wall.

13. The method in accordance with claim 1, wherein the polymer material mixture is composed by polymeric material and liquid crystal.

14. The method in accordance with claim 13, wherein the polymeric material mixture is provided with a spacer.

15. A method for manufacturing liquid crystal display comprising the steps of:
proceeding a first substrate process, coating photo polymeric material on an auxiliary substrate which has release layer and exposure by ultraviolet rays; making special electrode pattern of flange and coating alignment layer on the cured photo polymeric material layer;
proceeding a second substrate process, coating photo polymeric material mixtures on a substrate which has electrode pattern and alignment layer; and
proceeding the first and second substrate combine process,
aligning the auxiliary substrate and substrate and exposure to forms a plurality of polymer walls and assembling the first and second substrate to wrap the liquid crystal material with the polymer due to because phase separate of liquid crystal and photo polymeric material; and removing the auxiliary substrate.

16. The method in accordance with claim 15, wherein the photo polymeric material is photocurable resin.

17. The method in accordance with claim 15, wherein the material of assist substrate or substrate is one glass, wafer, Teflon and plastic substrate.

18. The method in accordance with claim 15, wherein the electrode pattern material is conducting film.

19. The method in accordance with claim 18, wherein the conducting film is one ITO and polyethylene-dioxithiphene.

20. The method in accordance with claim 15, wherein the release layer material is one of PE/PEWax, long-chain Aliphatic, Silicone and Teflon type materials.

21. The method in accordance with claim 15, wherein further comprising a manufacturing electrode step on the auxiliary substrate within the first substrate process step.

22. The method in accordance with claim 15, wherein the alignment layer process is performed by rubbing alignment, photoalignment, ion beam alignment or microgroove alignment and so on.

23. The method in accordance with claim 22, wherein the phase materials is polyimide, polyamic or photo phase material.

24. The method in accordance with claim 15, wherein making special electrode pattern or flange on the auxiliary substrate or substrate the flange being organic material.

25. The method in accordance with claim 15, wherein the polymer wall is closed matrix polymer wall.

26. The method in accordance with claim 15, wherein the polymer wall is non-closed matrix polymer wall.

27. The method in accordance with claim 15, wherein the polymer material mixture is composed by polymeric material and liquid crystal.

28. The method in accordance with claim 27, wherein the polymeric material mixture is provided with a spacer.

29. A method for manufacturing the liquid crystal display comprising the steps of:
proceeding a first substrate process, coating a photo of polymeric material on an auxiliary substrate which has release layer and exposured by ultraviolet rays; coating alignment layer on the cured photo polymeric material layer;
proceeding a second substrate process, coating a photo polymeric material mixtures on a substrate which has release layer; coating an electrode pattern and a alignment layer; and
proceeding the first and second substrate assembling process,
aligning the auxiliary substrate and substrate and exposuring the resulting structure to forms a plurality of polymer walls and assembling the first and second substrate to wrap the liquid crystal material with the polymer due to phase separation of liquid crystal and photo polymeric material; and
removing the auxiliary substrate.

30. The method in accordance with claim 29, wherein the photo polymeric material is photocurable resin.

31. The method in accordance with claim 29, wherein the material of auxiliary substrate or substrate is one of glass, wafer, Teflon and plastic substrate.

32. The method in accordance with claim 29, wherein the electrode pattern material is conducting film.

33. The method in accordance with claim 32, wherein the conducting film is ITO or polyethylene-dioxithiphene.

34. The method in accordance with claim 29, wherein the release layer material is PE/PEWax, long-chain Aliphatic, Silicone and Teflon type materials.

35. The method in accordance with claim 29, wherein further comprising a manufacturing electrode step on the auxiliary substrate within the first substrate process step.

36. The method in accordance with claim 29, wherein the alignment layer process method by rubbing alignment, or photoalignment, ion beam alignment or microgroove alignment and so on.

37. The method in accordance with claim 36, wherein the phase materials is polyimide, polyamic or photo phase material.

38. The method in accordance with claim 29, wherein making special electrode pattern or flange on the auxiliary substrate or substrate the flange being organic material.

39. The method in accordance with claim 29, wherein the polymer wall is closed matrix polymer wall.

40. The method in accordance with claim 29, wherein the polymer wall which is formed by polymeric material is non-closed matrix polymer wall.

41. The method y in accordance with claim 29, wherein the polymer material mixture is composed by polymeric material and liquid crystal.

42. The method in accordance with claim 41, wherein the polymeric material mixture is provided with a spacer.
